(19) United States
(12) Patent Application Publication
(10) Pub. No.: US 2009/0031754 A1
(43) Pub. Date: Feb. 5, 2009

(54) METHOD AND APPARATUS TO IMPROVE OVERALL EFFICIENCY OF LNG LIQUEFACTION SYSTEMS

(75) Inventor: AKIHIRO USHITORA, Yokohama (JP)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(73) Assignee: Ebara International Corporation, Sparks, NV (US)

(21) Appl. No.: 11/739,090

(22) Filed: Apr. 23, 2007

Related U.S. Application Data
(60) Provisional application No. 60/793,964, filed on Apr. 22, 2006.

(51) Int. Cl. F25J 1/00; F02C 3/28

(52) U.S. Cl. 62/611; 60/39.12

(57) ABSTRACT

For a LNG (liquid natural gas) liquefaction system or plant that includes a gas turbine fueled by vaporized LNG and which receives compressed air, via an air compressor, as an input, a means and method to use relatively colder LNG vapor, in a heat exchanger disposed before the inlet to the turbine's air compressor, to remove heat from the air being inputted to the air compressor to improve overall efficiency of the systems or plants.

This application claims the benefit of U.S. Provisional Application No. 60/793,964 filed Apr. 22, 2006.

### BACKGROUND OF THE INVENTION

This invention relates in general to LNG liquefaction systems or plants that include a gas turbine fueled by vaporized LNG and which receive compressed air, via an air compressor, as an input, and in particular this invention relates to a means and method to use relatively colder LNG vapor to remove heat from the air being inputted to the turbines' air compressors to improve overall efficiency of the systems or plants. As used herein the term “LNG” refers to liquid natural gas (primarily methane) which has been liquefied by refrigeration below the boiling point (e.g. −161,5° C., 111,7K depending on constituents of the gas) for storage and transport.

Other advantages and attributes of this invention will be readily discernable upon a reading of the text hereinafter.

### SUMMARY OF THE INVENTION

An object of this invention is to provide a means and method to improve overall efficiency of LNG liquefaction systems.

These objects, and other objects expressed or implied in this document, are accomplished by a means and method incorporated in an LNG liquefaction system or plant that includes a gas turbine fueled by vaporized LNG and which receives compressed air, via an air compressor, as an input, the means and method using relatively colder LNG vapor produced by an LNG expander or a Joule-Thomson valve to cool the air in a heat exchanger disposed before the inlet to the air compressor, to improve the compressor, gas turbine and overall plant efficiency.

### BRIEF DESCRIPTION OF THE DRAWINGS

FIG. 1 is a flow schematic representation of this invention.

### DESCRIPTION OF THE PREFERRED EMBODIMENT

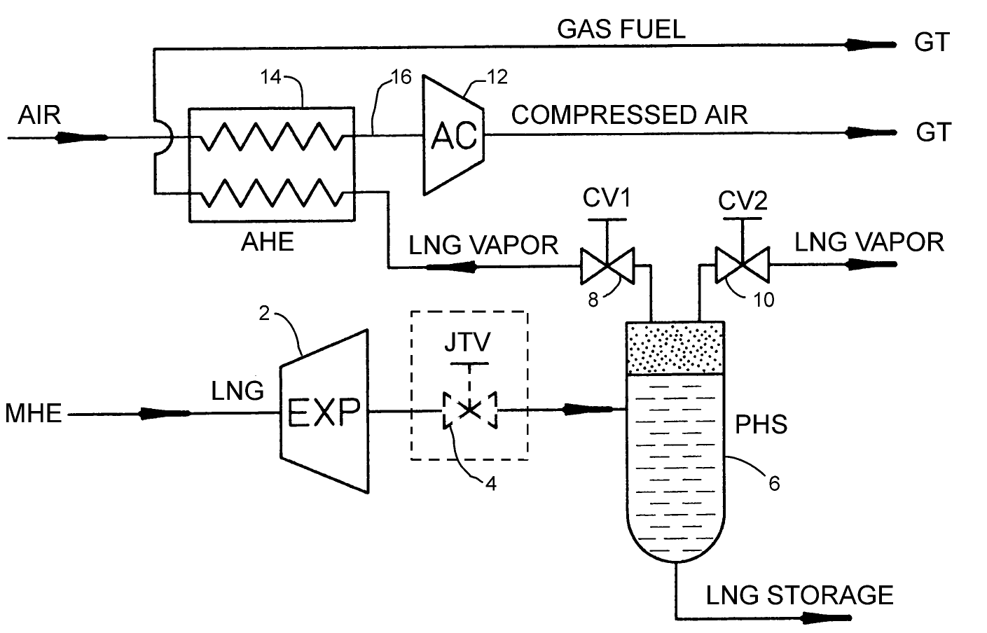

Referring to FIG. 1 a plant incorporating this invention is illustrated. The term MHE refers to a main heat exchanger typically found in plants and systems as described herein. The term EXP refers to a conventional LNG expander 2, and JTV refers to a Joule-Thomson valve 4. In general a Joule-Thomson valve is valve through which a fluid is allowed to expand adiabatically, resulting in lowering of its temperature. The Joule-Thomson valve 4 is shown in phantom because it can be used in-line in place of the EXP or in conjunction with the EXP. Preferably the EXP is a two-phase expander but not necessarily so. The term PHS refers to a conventional LNG phase separator 6; CV1 refers to a first conventional gas control valve 8, and CV2 to a second conventional gas control valve 10. AC refers to the aforesaid air compressor 12; GT refers to the gas turbine; and AHE refers to an air/LNG vapor heat exchanger 14 according to this invention. In general a Joule-Thomson valve is valve through which a fluid is allowed to expand adiabatically, resulting in lowering of its temperature.

Certain conventional LNG liquefaction systems and plants are powered by gas turbines. The fuel gas for the gas turbines is in many case clean vaporized LNG. The vaporized LNG is preferably produced by a two-phase LNG expander or alternatively by a Joule-Thomson valve. The vaporized LNG in the PHS is at its cold boiling temperature, as mentioned above, which is considerably colder than ambient air. Feeding some of the cold LNG vapor, depending on the settings of the CV1 and CV2 valves, can be used in the AHE to remove heat form the air at the inlet 16 of the air compressor 12 of the gas turbine GT.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims.

I claim:

1. For a liquid natural gas liquefaction system or plant that includes a gas turbine fueled by vaporized liquid natural gas and which receives compressed air, via an air compressor, as an input to a gas turbine, a method to improve efficiency comprising the step of using some of the liquid natural gas vapor to remove heat from relatively warmer air being inputted to the air compressor.

2. The method according to claim 2 wherein said some of the liquid natural gas vapor is fed from a liquid natural gas phase separator.

3. The method according to claim 3 wherein said the rate of said some of the liquid natural gas vapor being fed from a phase separator is controlled by a valve.

4. The method according to claim 2 wherein said some of the liquid natural gas vapor being fed from a phase separator is fed through an air/liquid natural gas heat exchanger in which it removes heat from said air.

5. For a liquid natural gas liquefaction system or plant that includes a gas turbine fueled by vaporized liquid natural gas, and which receives compressed air, via an air compressor, as an input to a gas turbine, and that includes a liquid natural gas phase separator, a device for improving overall efficiency comprising:
(a) a heat exchanger preceding in-line the air input of the air compressor, one input of the exchanger being air; and
(b) a line feeding some relatively colder liquid natural gas from a phase separator to another input of the heat exchanger, heat being exchanged within the exchanger from the incoming air to the incoming liquid natural gas.

6. The device according to claim 5 further comprising a control valve controlling the rate of flow from the phase separator to the heat exchanger.

7. The device according to claim 5 wherein the phase separator receives liquid natural gas from an expander or a Joule-Thomson valve.

8. The device according to claim 5 wherein the liquid natural gas passing through the heat exchanger is the fed to the gas turbine as fuel.

9. The device according to claim 6 wherein the liquid natural gas passing through the heat exchanger is the fed to the gas turbine as fuel.

10. The device according to claim 7 wherein the liquid natural gas passing through the heat exchanger is the fed to the gas turbine as fuel.
